(19) United States
(12) Patent Application Publication
(10) Pub. No.: US 2019/0369235 A1
(43) Pub. Date: Dec. 5, 2019

(54) RAINFALL INTENSITY ESTIMATION METHOD USING MULTIPLE ELEVATION OBSERVATION DATA OF K-BAND DUAL-POLARIZATION RADAR AT VERY SHORT DISTANCE

(71) Applicant: KOREA INSTITUTE OF CIVIL ENGINEERING AND BUILDING TECHNOLOGY, Goyang-si, Gyeonggi-do (KR)

(72) Inventors: Sang Hun LIM, Goyang-si (KR); Won KIM, Seoul (KR)

(73) Assignee: Korea Institute of Civil Engineering and Building Technology, Goyang-si, Gyeonggi-do (KR)

(21) Appl. No.: 16/477,007

(22) PCT Filed: Nov. 20, 2017
(86) PCT No.: PCT/KR2017/013165

§ 371 Date: Jul. 10, 2019

(30) Foreign Application Priority Data
Jan. 16, 2017 (KR) 10-2017-0007073

(51) Int. Cl. G01S 13/95; G01S 7/41; G01W 1/10

(52) U.S. Cl. CPC G01S 13/951; G01W 1/10; G01S 7/41

(57) ABSTRACT

Provided is a rainfall intensity estimation method, including the steps of: receiving specific differential phases, horizontal reflectivities, and differential reflectivities as scan observation data of the multiple elevation observation of the dual-polarization radar observing the very short distance according to elevation angles observed; calculating horizontal attenuations for scans from the horizontal reflectivities among the multiple elevation observation data; calculating vertical attenuations for the scans from the horizontal reflectivities and the differential reflectivities among the multiple elevation observation data; obtaining a volume mean of the horizontal attenuations for the scans, a volume mean of the vertical attenuations for the scans, a volume mean of the specific differential phases, a volume mean of the specific differential phases, a volume mean of the horizontal reflectivities, and a volume mean of the differential reflectivities; and estimating a rainfall intensity from at least one of the volume means.

### TECHNICAL FIELD

The present invention relates to a rainfall intensity estimation method using multiple elevation observation data of a K-band dual-polarization radar at a very short distance, and more particularly, to a rainfall intensity estimation method using multiple elevation observation data of a K-band dual-polarization radar at a very short distance that is capable of estimating a rainfall intensity through scan observation data of the dual-polarization radar and a concept of volume rainfall.

### BACKGROUND ART

Rainfall estimation using a dual-polarization radar is carried out with a differential reflectivity Z_{dr} and a specific differential phase K_{dp} as well as a reflectivity Zₕ used upon rainfall estimation of a single-polarization radar.

Representative rainfall estimation algorithms for the dual-polarization radar are a JPOLE (Joint Polarization Experiment) algorithm (Ryzhkov et al., 2005) and a CSU (Colorado State University) algorithm (Cifelli et al., 2011).

The JPOLE algorithm makes use of different rainfall relations according to amounts of rainfall, and the CSU algorithm makes use of different rainfall relations according to hydrometeors and qualities of radar data. The relations between variables used in the rainfall estimation algorithm, that is, R(Zₕ), R (Zₕ, Z_{dr}), R(K_{dp}), and R(K_{dp}, Z_{dr}) are obtained through theoretical studies on various assumptions for parameters of DSD (Drop Size Distribution) (Bringi and Chandrasekar, 2001).

According to the existing rainfall estimation methods, a rainfall intensity by gate is calculated through the data (for example, horizontal reflectivity, differential reflectivity, and specific differential phase) of the dual-polarization radar.

The existing rainfall estimation method for calculating a rainfall intensity value for each gate is adequate for a dual-polarization radar system observing a short distance (for example, 10 km), and unfortunately, it is hard to apply the existing rainfall estimation method to a radar system observing a very short distance (for example, 1 km or under). In this case, the radar system observing the very short distance should introduce a concept of volume rainfall so as to calculate the rainfall intensity value.

Accordingly, there is a need for developing a method for more accurately calculating a rainfall intensity value through the concept of volume rainfall in the existing radar system observing a very short distance.

### PRIOR ART DOCUMENT

### Patent Document

(Patent Document 1) Korean Patent No. 10-1512015 (issued on Apr. 8, 2015)

### DISCLOSURE

### Technical Problem

Accordingly, the present invention has been made in view of the above-mentioned problems occurring in the prior art, and it is an object of the present invention to provide a rainfall intensity estimation method using multiple elevation observation data of a dual-polarization radar observing a very short distance that estimates rainfall intensities in a unit of volume through reflectivity, differential reflectivity, specific differential phase, and other variables, thereby more accurately estimating the rainfall intensities than in the existing rainfall intensity estimation method.

The technical problems to be achieved through the present invention are not limited as mentioned above, and other technical problems not mentioned herein will be obviously understood to one of ordinary skill in the art through the following description.

### Technical Solution

To accomplish the above-mentioned object, according to the present invention, there is provided a rainfall intensity estimation method using multiple elevation observation data of a dual-polarization radar observing a very short distance, comprising the steps of: (A) receiving specific differential phases, horizontal reflectivities, and differential reflectivities as scan observation data of the multiple elevation observation of the dual-polarization radar observing the very short distance according to elevation angles observed; (B) calculating horizontal attenuations for scans from the horizontal reflectivities among the multiple elevation observation data; (C) calculating vertical attenuations for the scans from the horizontal reflectivities and the differential reflectivities among the multiple elevation observation data; (D) obtaining a volume mean of the horizontal attenuations for the scans calculated at the step (B), a volume mean of the vertical attenuations for the scans calculated at the step (C), a volume mean of the specific differential phases, a volume mean of the specific differential phases received at the step (A), a volume mean of the horizontal reflectivities received at the step (A), and a volume mean of the differential reflectivities received at the step (A); and (E) estimating a rainfall intensity from at least one of the volume mean of the horizontal attenuations, the volume mean of the vertical attenuations, the volume mean of the specific differential phases, the volume mean of the specific differential phases, the volume mean of the horizontal reflectivities, and the volume mean of the differential reflectivities.

According to the present invention, desirably, the step (B) calculates the horizontal attenuations from variations in the horizontal reflectivities according to irradiation distances of the dual-polarization radar, and the horizontal attenuations are calculated according to the scans corresponding to the elevation angles.

According to the present invention, desirably, the step (C) calculates the vertical attenuations from differences between the horizontal reflectivities and the differential reflectivities according to the irradiation distances of the dual-polarization radar, and the vertical attenuations are calculated according to the scans corresponding to the elevation angles.

According to the present invention, desirably, if the volume mean of the horizontal attenuations, the volume mean of the vertical attenuations, the volume mean of the specific differential phases, the volume mean of the horizontal reflectivities, and the volume mean of the differential reflectivities are greater than respective set threshold values, the step (E) estimates the rainfall intensity from the volume mean of the horizontal attenuations, the volume mean of the vertical attenuations, the volume mean of the specific differential phases, and the volume mean of the specific differential phases.

According to the present invention, desirably, if at least one of the volume mean of the horizontal reflectivities, the volume mean of the differential reflectivities, the volume mean of the specific differential phases, the volume means of the horizontal attenuations, and the volume mean of the vertical attenuations is less than the set threshold value, and if the volume mean of the horizontal reflectivities and the volume mean of the differential reflectivities are greater than the respective set threshold values, the step (E) estimates the rainfall intensity from the volume mean of the horizontal reflectivities and the volume mean of the differential reflectivities, and if at least one of the volume mean of the horizontal reflectivities and the volume mean of the differential reflectivities is less than the set threshold value, the step (E) estimates the rainfall intensity from the volume mean of the horizontal reflectivities.

### Advantageous Effects

According to the present invention, the rainfall intensity estimation method estimates the rainfall intensities through the horizontal attenuations and the vertical attenuations as well as the reflectivities, differential reflectivities, and specific differential phases, thereby more accurately estimating the rainfall intensities at the very short distance as well as at the short distance.

In addition, the rainfall intensity estimation method according to the present invention can more accurately estimate the rainfall intensities according to a unit of volume through the radar data observed and calculated at the multiple elevation angles, not at one elevation angle, that is, through the reflectivities, differential reflectivities, specific differential phases, horizontal attenuations, and vertical attenuations.

Further, the rainfall intensity estimation method according to the present invention can utilize the radar data obtained by scanning and observing the rays at the multiple elevation angles for a short period of time at the short distance, thereby solving various eco problems causing the radar data to be contaminated and preventing heavy rain and flood from occurring through the accurate rainfall estimation.

The effects of the present invention are not limited thereto, and other effects of the present invention will be clearly understood to those skilled in the art from the following description.

### BRIEF DESCRIPTION OF DRAWINGS

FIG. 1 is a graph showing observation results obtained by irradiating rays at multiple observation elevation angles in a rainfall intensity estimation apparatus according to the present invention.

FIG. 2 is a flowchart showing a rainfall intensity estimation method using multiple elevation observation data of a dual-polarization radar observing a very short distance according to the present invention.

FIG. 3 is a graph showing horizontal reflectivities of a first ray and a 360^{th} ray in scan data having n rays observed at an observation elevation angle of 45°.

FIG. 4 is graphs showing rainfall intensity distributions estimated at the observation elevation angles according to profiles in the rainfall intensity estimation method as explained with reference to FIG. 3.

FIG. 5 is a block diagram showing the rainfall intensity estimation apparatus using multiple elevation observation data of a dual-polarization radar observing a very short distance according to the present invention.

FIG. 6 is a graph showing the comparison result between estimated rainfall intensity values obtained through the rainfall intensity estimation apparatus and method of the present invention and true rainfall intensity values.

### MODE FOR INVENTION

Objects, characteristics and advantages of the present invention will be more clearly understood from the detailed description as will be described below and the attached drawings.

Hereinafter, the present invention will now be described in detail by way of particular examples. If it is determined that the detailed explanation on the well known technology related to the present invention makes the scope of the present invention not clear, the explanation will be avoided for the brevity of the description.

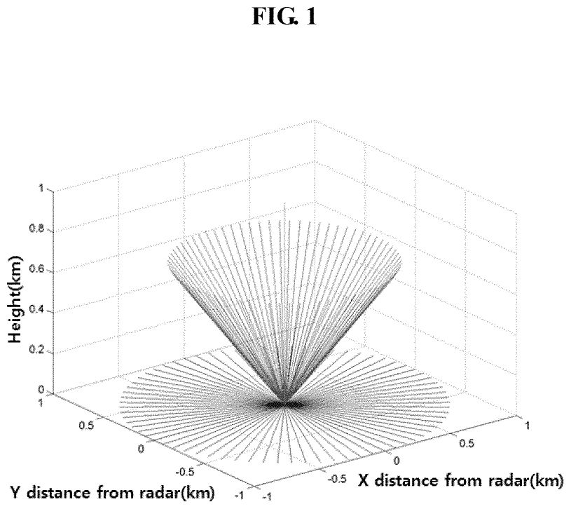

Those skilled in the art may easily infer that configurations of a rainfall intensity estimation apparatus 100 using dual-polarization variables as shown in FIG. 1 may be functionally and logically separated and it does not mean that each configuration should be distinguished as a separate physical device or created as a separate code.

Furthermore, the apparatus 100 using dual-polarization variables may be installed in a certain data processing apparatus to implement the spirit of the present invention.

In addition, the apparatus 100 may be one among all electronic devices that can install and execute a program, such as a desktop personal computer (PC), a server, a laptop PC, a netbook computer and the like, or may be implemented in any one of the electronic devices.

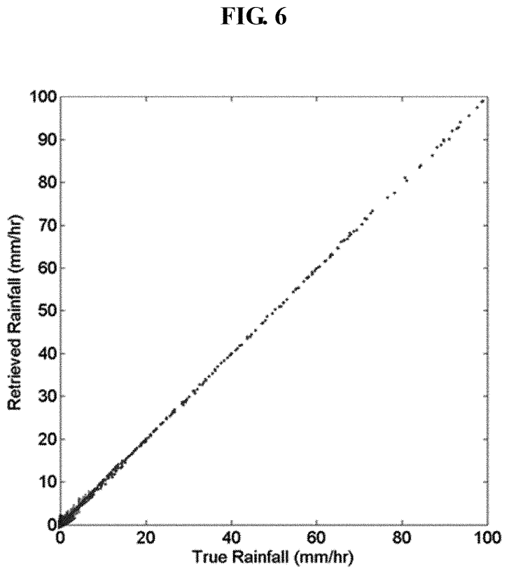

In addition, the apparatus 100 may have a memory that stores a rainfall intensity estimation program for estimating a rainfall intensity using multiple elevation observation data of k-band dual-polarization radar at very short distance. Further, the apparatus may have a processor that execute the stored a rainfall intensity estimation program to perform the operation described with reference to FIG. 6.

According to the present invention, first, a rainfall intensity estimation method using multiple elevation observation data of a dual-polarization radar observing a very short distance includes the step of irradiating K-band dual polarization rays through the dual-polarization radar; and if the rays are incident on a reflector, calculating values necessary for rainfall intensity estimation from the incident rays through a rainfall intensity estimation apparatus. Especially, the rainfall intensity estimation method according to the present invention estimates rainfall intensities through multiple observation elevation angle data on the condition that variations in amounts of rainfall are small during a short observation period of time at the short distance.

The dual-polarization radar and the rainfall intensity estimation apparatus may be provided as a single device, and according to the present invention, they will be explained in a state where they are separated from each other.

According to the present invention, for example, the very short distance is 1 km, but it may be greater than 1 km, without being limited thereto. Of course, the present invention can perform rainfall intensity estimation from the data obtained by irradiating rays onto a distance greater than 1 km even if the distance is not the very short distance.

According to the present invention, further, the multiple observation elevation angles include, for example, 0°, 45°, and 90°, and of course, they are not limited necessarily thereto.

FIG. 1 is a graph showing one volume data among multiple observation elevation angle data of the dual-polarization radar observing the very short distance in the rainfall intensity estimation apparatus according to the present invention.

As shown in FIG. 1, one volume data includes a plurality of scans, three scans according to the present invention, and one scan includes a plurality of rays. Moreover, one ray includes a plurality of gates.

Each of blue, red and green colors in FIG. 1 indicates one scan. The respective scans have 0°, 45°, and 90°. The scans indicated with the blue, red and green colors have the plurality of rays, and the number of rays is varied according to observation methods. According to the present invention, the number of rays is 360. The number of gates constituting each rayone of the blue, red and green lines) can be from tens to hundreds, depending on how the radar is operated.

There are various variables such as a horizontal reflectivity, differential reflectivity, and specific differential phase, and the like on one gate. According to the present invention, three variables, that is, horizontal reflectivity, differential reflectivity, and specific differential phase are used.

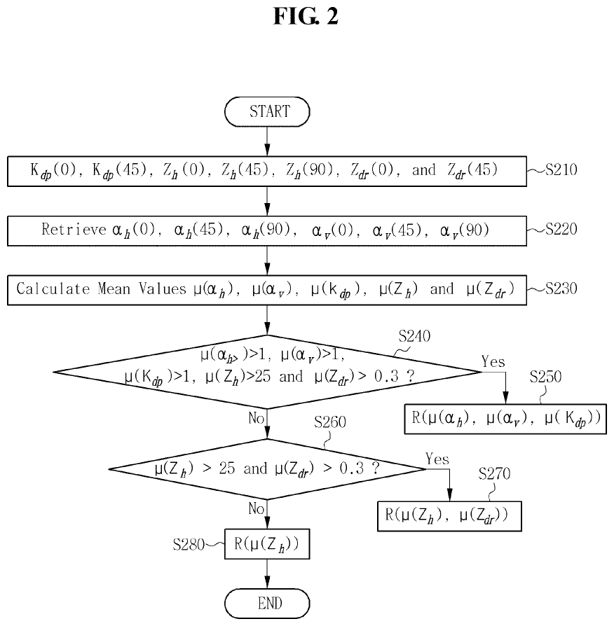

FIG. 2 is a flowchart showing a rainfall intensity estimation method using multiple elevation observation data of a dual-polarization radar observing a very short distance according to the present invention.

According to the present invention, as shown in FIG. 2, the rainfall intensity estimation apparatus receives scan observation data, that is, volume data made with the respective scan data at step S210. The scan observation data received at the step S210 are K_{dp}(0), K_{dp}(45), Zₕ(0), Zₕ(45), Zₕ(90), Z_{dr}(0), Z_{dr}(45), and Z_{dr}(90).

The K_{dp} (0) is a mean value of K_{dp} obtained in the scan of 0°. That is, the K_{dp} (0) is the mean value calculated from the plurality of rays having the plurality of gates. In the same manner as above, the K_{dp}(45) is a mean value of K_{dp} obtained in the scan of 45°.

The Zₕ(0) is a mean value of Zₕ obtained in the scan of 0°. That is, the Zₕ(0) is the mean value calculated from the plurality of rays having the plurality of gates. In the same manner as above, the Zₕ(45) is a mean value of Zₕ obtained in the scan of 45°, and the Zₕ(90) is a mean value of Zₕ obtained in the scan of 90°.

The Z_{dr} (0) is a mean value of Z_{dr} obtained in the scan of 0°. That is, the Z_{dr}(0) is the mean value calculated from the plurality of rays having the plurality of gates. In the same manner as above, the Z_{dr} (45) is a mean value of Z_{dr} obtained in the scan of 45°, and the Z_{dr}(90) is a mean value of Z_{dr} obtained in the scan of 90°.

Horizontal attenuations aₕ(0), aₕ(45), and aₕ(90) and vertical attenuations aᵥ(0), aᵥ(45), and aᵥ(90) for the scans according to the multiple elevation angles are obtained from the scan observation materials received at the step S210 through the rainfall intensity estimation apparatus at step S220.

First, an explanation on a method for calculating the horizontal attenuations aₕ(0), aₕ(45), and aₕ(90) for the scans at the step S220 will be given.

The horizontal attenuations are calculated from variations in the horizontal reflectivities according to the irradiation distances of the dual-polarization radar through the rainfall intensity estimation apparatus. That is, the horizontal attenuations for the rays are calculated from an inclination mean of the horizontal reflectivities for the rays through the rainfall intensity estimation apparatus. Next, the horizontal attenuation aₕ(0) for one scan (for example, scan of 0°) is calculated from a mean of the calculated horizontal attenuations for the rays. Through the above-mentioned manner, the horizontal attenuations aₕ(0), aₕ(45) and aₕ(90) for the scans of 0°, 45° and 90° are calculated through the rainfall intensity estimation apparatus.

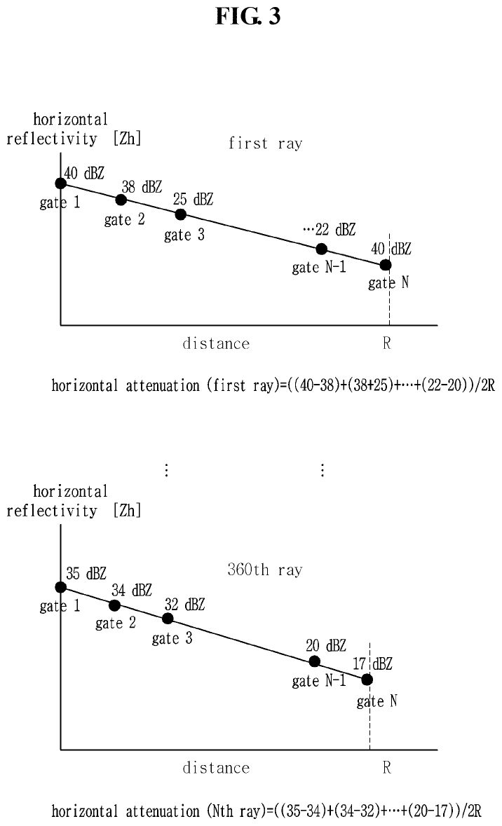

FIG. 3 is a graph showing a method for obtaining the horizontal attenuation for one scan according to the present invention.

FIG. 3 shows the horizontal reflectivities of a first ray and a 360th ray among 360 rays constituting one scan (for example, scan of 45°) according to the gates.

As shown in FIG. 3, a reference symbol R is a scan distance, and if one ray includes N gates, the horizontal reflectivities are values for a first gate to an Nth gate. The rainfall intensity estimation apparatus according to the present invention calculates the horizontal attenuations from the variations in the horizontal reflectivities according to the irradiation distances of the dual-polarization radar.

For example, the horizontal attenuation for the first ray is calculated from an inclination mean of the horizontal reflectivity of the first ray through the rainfall intensity estimation apparatus. The following mathematical expression 1 shows an expression for calculating the horizontal attenuation for the first ray.

$$Horizontal attenuation ( first ray ) = \frac{( 40 - 38 ) + ( 38 - 25 ) + … + ( 22 - 20 )}{2 R} \qquad [ Mathematical expression 1 ]$$

Further, the horizontal attenuation for the 360th ray is calculated from an inclination mean of the horizontal reflectivity of the 360th ray through the rainfall intensity estimation apparatus. The following mathematical expression 2 shows an expression for calculating the horizontal attenuation for the 360th ray.

$$Horizontal attenuation ( 360 th ray ) = \frac{( 35 - 34 ) + ( 34 - 32 ) + … + ( 20 - 17 )}{2 R} \qquad [ Mathematical expression 2 ]$$

Like the mathematical expression 1 and the mathematical expression 2, the horizontal attenuation for each of the 360 rays is calculated through the rainfall intensity estimation apparatus. The mean of the calculated horizontal attenuations for the 360 rays is calculated and defined as the horizontal attenuation aₕ(45) for one scan through the rainfall intensity estimation apparatus.

In the same manner as in the Mathematical expression 1 and the Mathematical expression 2, further, the horizontal attenuations aₕ(0) and aₕ(90) for the scans of 0° and 90° are calculated through the rainfall intensity estimation apparatus.

Next, an explanation on a method for calculating the vertical attenuations aᵥ(0), aᵥ(45), and aᵥ(90) for the scans at the step S220 will be given. The vertical attenuations are calculated from differences between the horizontal reflectivities and the differential reflectivities. That is, (horizontal reflectivity−differential reflectivity) vertical reflectivity. In the similar manner to the method as shown in FIG. 3, the vertical attenuations aᵥ(0), aᵥ(45), and aᵥ(90) for each of the respective scans (for example, scan of 0°, 45° and 90°) are calculated. In detail, the vertical attenuations are calculated from the differences between the horizontal reflectivities and the differential reflectivities calculated in the first gate to the Nth gate according to the irradiation distances of the dual-polarization radar through the rainfall intensity estimation apparatus.

The rainfall intensity estimation apparatus calculates the vertical attenuations for each of the 360 rays (the first ray to the 360th ray). Further, the rainfall intensity estimation apparatus calculates a mean of the calculated vertical attenuations for each of the 360 rays and determines the mean as the vertical attenuation aᵥ(45) for one scan. Furthermore, the rainfall intensity estimation apparatus calculates the vertical attenuations aᵥ(0) and aᵥ(90) for other scans (for example, 0° and 90°).

Referring again to FIG. 2, the rainfall intensity estimation apparatus calculates a volume mean μ(aₕ) of the horizontal attenuations aₕ(0), aₕ(45), and aₕ(90) for the respective observation elevation angles, that is, the scans, a volume mean μ(aᵥ) of the vertical attenuations aᵥ(0), aᵥ(45), and aᵥ(90) for the respective scans, a volume mean μ(K_{dp}) of the specific differential phases K_{dp}(0) and 2*K_{dp}(45), a volume mean μ(Zₕ) of the horizontal reflectivities Zₕ(0), Zₕ(45), and Zₕ(90), and a volume mean μ(Z_{dr}) of the differential reflectivities Z_{dr}(0) and 2*Z_{dr}(45) at step S230.

Referring in detail to the step S230, first, the rainfall intensity estimation apparatus calculates the volume mean μ(aₕ) of the calculated horizontal attenuations for the scans at the step S220 and the volume mean μ(aᵥ) of the calculated vertical attenuations for the respective scans at the step S220. For example, the rainfall intensity estimation apparatus determines a mean or intermediate value of the horizontal attenuations as a volume mean μ(aₕ) and determines a mean or intermediate value of the vertical attenuations as a volume mean μ(aᵥ).

Further, the rainfall intensity estimation apparatus calculates a mean or intermediate value of the specific differential phases K_{dp}(0) and 2*K_{dp}(45), received at the step S210 as a volume mean μ(K_{dp}) of the specific differential phases.

Moreover, the rainfall intensity estimation apparatus calculates a mean or intermediate value of the horizontal reflectivities Zₕ (0), Zₕ (45), and Zₕ(90) received at the step S210 as a volume mean μ(Zₕ) of the horizontal reflectivities.

Also, the rainfall intensity estimation apparatus calculates a mean or intermediate value of the differential reflectivities Z_{dr}(0) and 2*Z_{dr}(45) received at the step S210 as a volume mean μ(Z_{dr}) of the differential reflectivities.

The volume mean μ (aₕ) of the calculated horizontal attenuations, the volume mean μ(aᵥ) of the calculated vertical attenuations, the volume mean μ (K_{dp}) of the specific differential phases, the volume mean μ(Zₕ) of the horizontal reflectivities, and the volume mean μ (Z_{dr}) of the differential reflectivities for the scans of 0°, 45° and 90° are as follows.

μ(aₕ)=mean(aₕ(0),aₕ(45),aₙ(90))

μ(aᵥ)=mean(aᵥ(0),aᵥ(45),aᵥ(90))

μ(K_{dp})=mean(K_{dp}(0),2*K_{dp}(45))

μ(Zₕ)=mean(Zₕ(0),Zₕ(45),Zₕ(90))

μ(Z_{dr})=mean(Z_{dr}(0),2*Z_{dr}(45))

The rainfall intensity estimation apparatus estimates a rainfall intensity through at least one of the volume mean μ(aₕ) of the horizontal attenuations, the volume mean μ (aᵥ) of the vertical attenuations, the volume mean μ (K_{dp}) of the specific differential phases, the volume mean μ(Zₕ) of the horizontal reflectivities, and the volume mean μ(Z_{dr}) of the differential reflectivities at steps S240 to S280, which have been calculated at the step S230.

The rainfall intensity estimation at the steps S240 to S280 will be in detail explained below.

First, if the volume mean μ (aₕ) of the horizontal attenuations, the volume mean μ(aᵥ) of the vertical attenuations, the volume mean μ(K_{dp}) of the specific differential phases, the volume mean μ(Zₕ) of the horizontal reflectivities, and the volume mean μ(Z_{dr}) of the differential reflectivities are greater than respective set threshold values 1, 1, 1, 25 and 0.3 in sequential order, the rainfall intensity estimation apparatus determines that the rainfall intensity is high and the data calculated at the steps S210 and S220 has relatively high reliability. Accordingly, the rainfall intensity estimation apparatus estimates the rainfall intensity from the volume mean μ(aₕ) of the horizontal attenuations, the volume mean μ(aᵥ) of the vertical attenuations, and the volume mean μ(K_{dp}) of the specific differential phases through a Mathematical expression 3 at the step S250.

R(μ(aₕ),μ(aᵥ),μ(K_{dp}))=a*μ(aₕ)+b*μ(aᵥ)+C*μ(K_{dp}) [Mathematical expression 3]

In the Mathematical expression 3, a, b and c are variables in frequencies, and for example, a=60.2, b=−6.6, and c=−45.2, in 24 GHz. A 24 GHz frequency is one of commercial frequencies, and the variables, a, b and c are theoretical values obtained through a scattering simulation. Accordingly, theoretical values in other frequencies may be obtained in the same manner as the 24 GHz frequency. The R(μ(aₕ), μ(aᵥ), μ(K_{dp})) are the rainfall intensities estimated with the volume mean μ(aₕ) of the horizontal attenuations, the volume mean μ(aᵥ) of the vertical attenuations, and the volume mean μ(K_{dp}) of the specific differential phases.

To the contrary, at the step S240, if at least one of the volume mean μ(aₕ) of the horizontal attenuations, the volume mean μ(aᵥ) of the vertical attenuations, the volume mean μ(K_{dp}) of the specific differential phases, the volume mean μ(Zₕ) of the horizontal reflectivities, and the volume mean μ(Z_{dr}) of the differential reflectivities is less than the respective set threshold values 1, 1, 1, 25 and 0.3 in sequential order, the rainfall intensity estimation apparatus compares the volume mean μ(Zₕ) of the horizontal reflectivities and the volume mean μ(Z_{dr}) of the differential reflectivities with their respective set threshold values 25 and 0.3 at the step S260.

At the step S260, if the volume mean μ(Zₕ) of the horizontal reflectivities and the volume mean μ(Z_{dr}) of the differential reflectivities are greater than their respective set threshold values 25 and 0.3, the rainfall intensity estimation apparatus estimates the rainfall intensity from the volume mean μ(Zₕ) of the horizontal reflectivities and the volume mean μ(Z_{dr}) of the differential reflectivities through a Mathematical expression 4 at the step S270.

R(μ(Zₕ),μ(Z_{dr}))=d*(μ(Zₕ))^{e}*(μ(Z_{dr}))^{f} [Mathematical expression 4]

In the Mathematical expression 4, d, e and f are variables in frequencies, and for example, d=0.0105, e=1.0012, and f=−21.52, in 24 GHz. The R(μ(Zₕ), μ(Z_{dr})) is the rainfall intensity estimated from the volume mean μ(Zₕ) of the horizontal reflectivities and the volume mean μ(Z_{dr}) of the differential reflectivities.

To the contrary, at the step S260, if at least one of the volume mean μ(Zₕ) of the horizontal reflectivities and the volume mean μ(Z_{dr}) of the differential reflectivities is less than the respective set threshold values (sequentially, 25 and 0.3), the rainfall intensity estimation apparatus applies the volume mean μ(Zₕ) of the horizontal reflectivities to a Mathematical expression 5 and obtains the rainfall intensity at the step S280.

R(μ(Zₕ))=g*(μ(Zₕ))^{h} [Mathematical expression 5]

In the Mathematical expression 5, g and h are variables in frequencies, and for example, g=0.0055 and h=0.9927, in 24 GHz. The R(μ(Zₕ) is the rainfall intensity estimated from the volume mean μ(Zₕ) of the horizontal reflectivities.

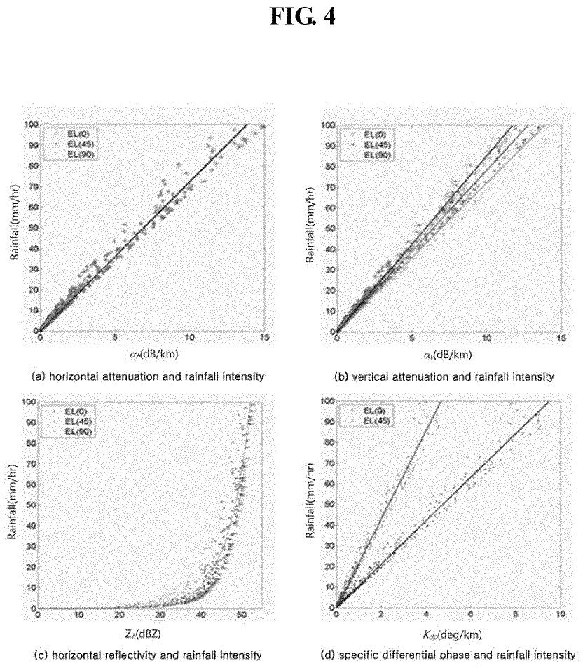

FIGS. 4A to 4D are graphs showing rainfall intensity distributions estimated at the observation elevation angles according to profiles in the rainfall intensity estimation method as explained with reference to FIG. 3.

As shown in FIGS. 4A to 4D, the profiles include the horizontal attenuations aₕ, vertical attenuations aᵥ, horizontal reflectivities Zₕ, and specific differential phases K_{dp}. Also, blue points EL(0) indicate rainfall intensities estimated at the elevation angle of 0°, red points EL(45) indicate rainfall intensities estimated at the elevation angle of 45°, and green points EL(90) indicate rainfall intensities estimated at the elevation angle of 90°.

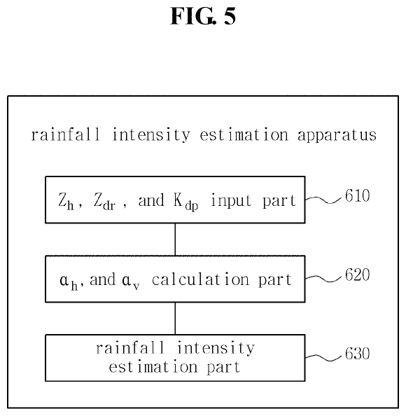

FIG. 5 is a block diagram showing the rainfall intensity estimation apparatus using multiple elevation observation data of a dual-polarization radar observing a very short distance according to the present invention.

The rainfall intensity estimation apparatus as shown in FIG. 5 is an apparatus for performing the rainfall intensity estimation as explained with reference to FIGS. 1 to 3, and therefore, a detailed explanation on the apparatus will be avoided.

Referring to FIG. 5, the rainfall intensity estimation apparatus includes a Zₕ, Z_{dr}, and K_{dp} input part 610, an aₕ and aᵥ calculation part 620, and a rainfall intensity estimation part 630.

The Zₕ, Z_{dr}, and K_{dp} input part 610 receives the scan observation data, that is, K_{dp} (0), K_{dp} (45), Zₕ(0), Zₕ(45), Zₕ(90), Z_{dr}(0), and Z_{dr}(45), among the multiple elevation observation data of the dual-polarization radar observing the very short distance.

The aₕ and aᵥ calculation part 620 obtains the horizontal attenuations aₕ(0), aₕ(45), and aₕ(90) and the vertical attenuations aᵥ(0), aᵥ(45), and aᵥ(90) for the scans according to the multiple elevation angles through the received scan observation data.

The aₕ and aᵥ calculation part 620 obtains the horizontal attenuations for the respective rays constituting one scan and calculates a mean of the horizontal attenuations for the respective rays as the horizontal attenuation for one scan. Accordingly, the aₕ and aᵥ calculation part 620 calculates the horizontal attenuation aₕ(0) for the scan of 0°, the horizontal attenuation aₕ(45) for the scan of 45°, and the horizontal attenuation aₕ(90) for the scan of 90°. In the similar manner to the above mentioned method, further, the aₕ and aᵥ calculation part 620 calculates the vertical attenuations aᵥ(0), aᵥ(45), and aᵥ(90) for the scans of 0°, 45°, and 90°.

The rainfall intensity estimation part 630 calculates a volume mean of the horizontal attenuations for the scans, a volume mean of the vertical attenuations for the scans, a volume mean of the specific differential phases, a volume mean of the horizontal reflectivities, and a volume mean of the differential reflectivities and compares the respective volume means with their threshold values to estimate the rainfall intensity.

For example, the rainfall intensity estimation part 630 estimates the rainfall intensity through at least one of the volume mean μ(aₕ) of the horizontal attenuations, the volume mean μ(aᵥ) of the vertical attenuations, the volume mean μ(K_{dp}) of the specific differential phases, the volume mean μ(Zₕ) of the horizontal reflectivities, and the volume mean μ(Z_{dr}) of the differential reflectivities.

If μ(aₕ)>1, μ(aᵥ)>1, μ(K_{dp})>1, μ(Zₕ)>25, and μ(Z_{dr})>0.3, further, the rainfall intensity estimation part 630 estimates the rainfall intensity through the Mathematical expression 3.

If at least one of μ(aₕ), μ(aᵥ), μ(K_{dp}) μ(Zₕ), and μ(Z_{dr}) is less than their respective set threshold values 1, 1, 1, 25 and 0.3 in sequential order, further, the rainfall intensity estimation part 630 compares μ(Zₕ) and μ(Z_{dr}) with their set threshold values 25 and 0.3. As a result of the comparison, if μ(Zₕ) and μ(Z_{dr}) are greater than their set threshold values 25 and 0.3, the rainfall intensity estimation part 630 estimates the rainfall intensity through the Mathematical expression 4.

If at least one of μ(aₕ), μ(aᵥ), μ(K_{dp}), μ(Zₕ), and μ(Z_{dr}) is less than their respective set threshold values 1, 1, 1, 25 and 0.3 in the sequential order, furthermore, the rainfall intensity estimation part 630 compares μ(Zₕ) and μ(Z_{dr}) with their set threshold values 25 and 0.3. As a result of the comparison, if at least one of μ(Zₕ) and μ(Z_{dr}) are less than their set threshold values 25 and 0.3, the rainfall intensity estimation part 630 estimates the rainfall intensity through the Mathematical expression 5.

FIG. 6 is a graph showing the comparison result between estimated rainfall intensity values obtained through the rainfall intensity estimation apparatus and method of the present invention and a true rainfall intensity values.

As shown, ‘True Rainfall’ includes rainfall intensity measurement values (true values), and ‘Retrieved rainfall’ includes rainfall intensity estimation values. It can be appreciated from the graph as shown in FIG. 6 that there are no big differences between the rainfall intensity measurement values and the rainfall intensity estimation values.

In the other hand, the rainfall intensity estimation method using the multiple elevation observation data of the dual-polarization radar observing the very short distance according to the present invention has command programs implemented typologically, and accordingly, it will be easily understood to those having ordinary skill in the art that the rainfall intensity estimation method can be provided in computer readable media including the commands.

In detail, the rainfall intensity estimation method using the multiple elevation observation data of the dual-polarization radar observing the very short distance according to the present invention has the form of a program implemented through various computer means in such a manner as to be recorded in the computer readable media, and the computer readable media include program commands, data files, and data structures, alone or in combination with each other. The computer readable media include magnetic media like hard disks, optical media like CD-ROM and DVD, ROM, RAM, flash memory, and USB memory, in which the program commands are recorded and implemented.

So as to perform the rainfall intensity estimation method using the multiple elevation observation data of the dual-polarization radar observing the very short distance according to the present invention, accordingly, a program, which is recorded in the computer readable media and is implemented on a computer for controlling the rainfall intensity estimation apparatus, is provided together with the above-mentioned program.

1. A rainfall intensity estimation method using multiple elevation observation data of a dual-polarization radar observing a very short distance, comprising the steps of:
(A) receiving specific differential phases, horizontal reflectivities, and differential reflectivities as scan observation data of the multiple elevation observation of the dual-polarization radar observing the very short distance according to elevation angles observed;
(B) calculating horizontal attenuations for scans from the horizontal reflectivities among the multiple elevation observation data;
(C) calculating vertical attenuations for the scans from the horizontal reflectivities and the differential reflectivities among the multiple elevation observation data;
(D) obtaining a volume mean of the horizontal attenuations for the scans calculated at the step (B), a volume mean of the vertical attenuations for the scans calculated at the step (C), a volume mean of the specific differential phases, a volume mean of the specific differential phases received at the step (A), a volume mean of the horizontal reflectivities received at the step (A), and a volume mean of the differential reflectivities received at the step (A); and
(E) estimating a rainfall intensity from at least one of the volume mean of the horizontal attenuations, the volume mean of the vertical attenuations, the volume mean of the specific differential phases, the volume mean of the specific differential phases, the volume mean of the horizontal reflectivities, and the volume mean of the differential reflectivities.

2. The rainfall intensity estimation method according to claim 1, wherein the step (B) calculates the horizontal attenuations from variations in the horizontal reflectivities according to irradiation distances of the dual-polarization radar, and the horizontal attenuations are respectively calculated for the scans corresponding to the elevation angles.

3. The rainfall intensity estimation method according to claim 1, wherein the step (C) calculates the vertical attenuations from differences between the horizontal reflectivities and the differential reflectivities according to the irradiation distances of the dual-polarization radar, and the vertical attenuations are respectively calculated for the scans corresponding to the elevation angles.

4. The rainfall intensity estimation method according to claim 1, wherein if the volume mean of the horizontal attenuations, the volume mean of the vertical attenuations, the volume mean of the specific differential phases, the volume mean of the specific differential phases, the volume mean of the horizontal reflectivities, and the volume mean of the differential reflectivities are greater than respective set threshold values, the step (E) estimates the rainfall intensity from the volume mean of the horizontal attenuations, the volume mean of the vertical attenuations, and the volume mean of the specific differential phases.

5. The rainfall intensity estimation method according to claim 1, wherein if at least one of the volume mean of the horizontal reflectivities, the volume mean of the differential reflectivities, the volume mean of the specific differential phases, the volume means of the horizontal attenuations, and the volume mean of the vertical attenuations is less than the set threshold value, and if the volume mean of the horizontal reflectivities and the volume mean of the differential reflectivities are greater than the respective set threshold values, the step (E) estimates the rainfall intensity from the volume mean of the horizontal reflectivities and the volume mean of the differential reflectivities, and if at least one of the volume mean of the horizontal reflectivities and the volume mean of the differential reflectivities is less than the set threshold value, the step (E) estimates the rainfall intensity from the volume mean of the horizontal reflectivities.
